(19) United States
(12) Patent Application Publication
(10) Pub. No.: US 2015/0042799 A1
(43) Pub. Date: Feb. 12, 2015

(54) OBJECT HIGHLIGHTING AND SENSING IN VEHICLE IMAGE DISPLAY SYSTEMS

(71) Applicant: GM GLOBAL TECHNOLOGY OPERATIONS LLC, DETROIT, MI (US)

(72) Inventors: Wende Zhang, Troy, MI (US); Jinsong Wang, Troy, MI (US); Bakhtiar B. Litkouhi, Washington, MI (US); Dennis B. Kazensky, Farmington Hills, MI (US); Jeffrey S. Piasecki, Rochester, MI (US); Charles A. Green, Canton, MI (US); Ryan M. Frakes, Bloomfield Hills, MI (US)

(73) Assignee: GM GLOBAL TECHNOLOGY OPERATIONS LLC, DETROIT, MI (US)

(21) Appl. No.: 14/059,729

(22) Filed: Oct. 22, 2013

Related U.S. Application Data
(60) Provisional application No. 61/863,087, filed on Aug. 7, 2013.

(51) Int. Cl. G06K 9/00; H04N 7/18

(52) U.S. Cl. CPC G06K 9/00805; H04N 7/18
USPC 348/148

(57) ABSTRACT

A method of displaying a captured image on a display device of a driven vehicle. A scene exterior of the driven vehicle is captured by an at least one vision-based imaging device mounted on the driven vehicle. Objects in a vicinity of the driven vehicle are sensed. An image of the captured scene is generated by a processor. The image is dynamically expanded to include sensed objects in the image. The sensed objects are highlighted in the dynamically expanded image. The highlighted objects identify vehicles proximate to the driven vehicle that are potential collisions to the driven vehicle. The dynamically expanded image is displayed with highlighted objects in the display device.

### CROSS-REFERENCE TO RELATED APPLICATIONS

This application claims priority of U.S. Provisional Application Ser. No. 61/863,087 filed Aug. 7, 2013, the disclosure of which is incorporated by reference.

### BACKGROUND OF INVENTION

An embodiment relates generally to image capture and display in vehicle imaging systems.

Vehicle systems often use in-vehicle vision systems for rear-view scene detection. Many cameras may utilize a fisheye camera or similar that distorts the captured image displayed to the driver such as a rear back up camera. In such instance when the view is reproduced on the display screen, due to distortion and other factors associated with the reproduced view, objects such as vehicles approaching to the sides of the vehicle may be distorted as well. As a result, the driver of the vehicle may not take notice that of the object and its proximity to the driven vehicle. As a result, a user may not have awareness of a condition where the vehicle could be a potential collision to the driven vehicle if the vehicle crossing paths were to continue, as in the instance of a backup scenario, or if a lane change is forthcoming. While some vehicle system of the driven vehicle may attempt to ascertain the distance between the driven vehicle and the object, due to the distortions in the captured image, such system may not be able to determine such parameters that are required for alerting the driver of relative distance between the object and a vehicle or when a time-to-collision is possible.

### SUMMARY OF INVENTION

An advantage of an embodiment is the display of vehicles in a dynamic rearview mirror where the objects such as vehicles are captured by a vision based capture device and objects identified are highlighted for generating an awareness to the driver of the vehicle and a time-to-collision is identified for highlighted objects. The time-to-collision is determined utilizing temporal differences that are identified by generating an overlay boundary about changes to the object size and the relative distance between the object and the driven vehicle.

In addition, detection of objects by sensing devices other than the vision-based capture device are cooperatively used to provide a more accurate location of an object. The data from the other sensing devices are fused with data from the vision based imaging device for providing a more accurate location of the position of the vehicle relative to the driven vehicle.

An embodiment contemplates a method of displaying a captured image on a display device of a driven vehicle. A scene exterior of the driven vehicle is captured by an at least one vision-based imaging device mounted on the driven vehicle. Objects in a vicinity of the driven vehicle are sensed. An image of the captured scene is generated by a processor. The image is dynamically expanded to include sensed objects in the image. The sensed objects are highlighted in the dynamically expanded image. The highlighted objects identify vehicles proximate to the driven vehicle that are potential collisions to the driven vehicle. The dynamically expanded image is displayed with highlighted objects in the display device.

### BRIEF DESCRIPTION OF DRAWINGS

FIG. 1 is an illustration of a vehicle including a surround view vision-based imaging system.

FIG. 2 is an illustration for a pinhole camera model.

FIG. 3 is an illustration of a non-planar pin-hole camera model.

FIG. 4 is a block flow diagram utilizing cylinder image surface modeling.

FIG. 5 is a block flow diagram utilizing an ellipse image surface model.

FIG. 6 is a flow diagram of view synthesis for mapping a point from a real image to the virtual image.

FIG. 7 is an illustration of a radial distortion correction model.

FIG. 8 is an illustration of a severe radial distortion model.

FIG. 9 is a block diagram for applying view synthesis for determining a virtual incident ray angle based on a point on a virtual image.

FIG. 10 is an illustration of an incident ray projected onto a respective cylindrical imaging surface model.

FIG. 11 is a block diagram for applying a virtual pan/tilt for determining a ray incident ray angle based on a virtual incident ray angle.

FIG. 12 is a rotational representation of a pan/tilt between a virtual incident ray angle and a real incident ray angle.

FIG. 13 is a block diagram for displaying the captured images from one or more image capture devices on the rearview mirror display device.

FIG. 14 illustrates a block diagram of a dynamic rearview mirror display imaging system using a single camera.

FIG. 15 illustrates a flowchart for adaptive dimming and adaptive overlay of an image in a rearview mirror device.

FIG. 16 illustrates a flowchart of a first embodiment for identifying objects in a rearview mirror display device.

FIG. 17 is an illustration of rear view display device executing a rear cross traffic alert.

FIG. 18 is an illustration of a dynamic rearview display device executing a rear cross traffic alert.

FIG. 19 illustrates a flowchart of a second embodiment for identifying objects in a rearview mirror display device.

FIG. 20 is illustration of a dynamic image displayed on the dynamic rearview mirror device for the embodiment described in FIG. 19.

FIG. 21 illustrates a flowchart of a third embodiment for identifying objects in a rearview mirror display device.

FIG. 22 illustrates a flowchart of the time to collision and image size estimation approach.

FIG. 23 illustrates an exemplary image captured by an object capture device at a first instance of time.

FIG. 24 illustrates an exemplary image captured by an image capture device at a second instance of time.

FIG. 25 illustrates a flowchart of the time to collision estimation approach through point motion estimation in the image plane.

FIG. 26 illustrates a flowchart of a fourth embodiment for identifying objects on the rearview mirror display device.

### DETAILED DESCRIPTION

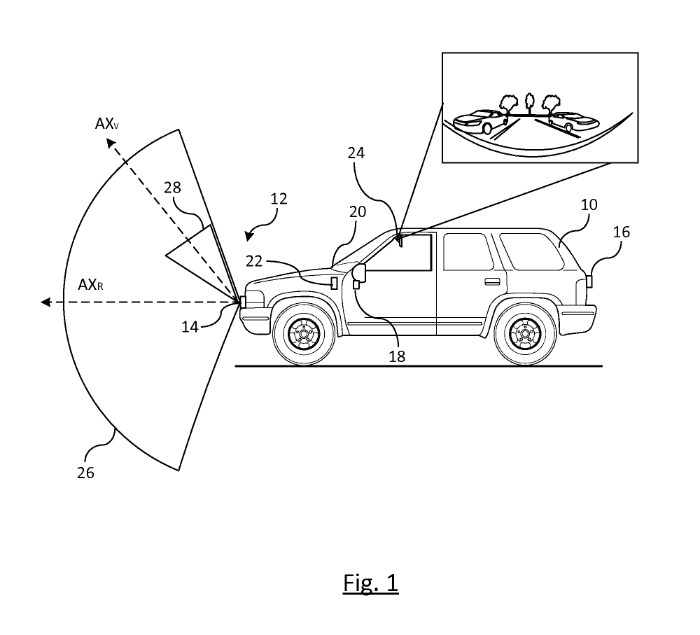

There is shown in FIG. 1, a vehicle 10 traveling along a road. A vision-based imaging system 12 captures images of the road. The vision-based imaging system 12 captures images surrounding the vehicle based on the location of one or more vision-based capture devices. In the embodiments described herein, the vision-based imaging system captures images rearward of the vehicle, forward of the vehicle, and to the sides of the vehicle.

The vision-based imaging system 12 includes a front-view camera 14 for capturing a field-of-view (FOV) forward of the vehicle 10, a rear-view camera 16 for capturing a FOV rearward of the vehicle, a left-side view camera 18 for capturing a FOV to a left side of the vehicle, and a right-side view camera 20 for capturing a FOV on a right side of the vehicle. The cameras 14-20 can be any camera suitable for the purposes described herein, many of which are known in the automotive art, that are capable of receiving light, or other radiation, and converting the light energy to electrical signals in a pixel format using, for example, charged coupled devices (CCD). The cameras 14-20 generate frames of image data at a certain data frame rate that can be stored for subsequent processing. The cameras 14-20 can be mounted within or on any suitable structure that is part of the vehicle 10, such as bumpers, facie, grill, side-view mirrors, door panels, behind the windshield, etc., as would be well understood and appreciated by those skilled in the art. Image data from the cameras 14-20 is sent to a processor 22 that processes the image data to generate images that can be displayed on a review mirror display device 24. It should be understood that a one camera solution is included (e.g., rearview) and that it is not necessary to utilize 4 different cameras as describe above.

The present invention utilizes the captured scene from the vision imaging based device 12 for detecting lighting conditions of the captured scene, which is then used to adjust a dimming function of the image display of the rearview mirror 24. Preferably, a wide angle lens camera is utilized for capturing an ultra-wide FOV of a scene exterior of the vehicle, such a region represented by 26. The vision imaging based device 12 focuses on a respective region of the captured image, which is preferably a region that includes the sky 28 as well as the sun, and high-beams from other vehicles at night. By focusing on the illumination intensity of the sky, the illumination intensity level of the captured scene can be determined. This objective is to build a synthetic image as taken from a virtual camera having an optical axis that is directed at the sky for generating a virtual sky view image. Once a sky view is generated from the virtual camera directed at the sky, a brightness of the scene may be determined. Thereafter, the image displayed through the rearview mirror 24 or any other display within the vehicle may be dynamically adjusted. In addition, a graphic image overlay may be projected onto the image display of the rearview mirror 24. The image overlay replicates components of the vehicle (e.g., head rests, rear window trim, c-pillars) that includes line-based overlays (e.g., sketches) that would typically be seen by a driver when viewing a reflection through the rearview mirror having ordinary reflection properties. The image displayed by the graphic overlay may also be adjusted as to the brightness of the scene to maintain a desired translucency such that the graphic overlay does not interfere with the scene reproduced on the rearview mirror, and is not washed out.

In order to generate the virtual sky image based on the capture image of a real cameral, the captured image must be modeled, processed, and view synthesized for generating a virtual image from the real image. The following description details how this process is accomplished. The present invention uses an image modeling and de-warping process for both narrow FOV and ultra-wide FOV cameras that employs a simple two-step approach and offers fast processing times and enhanced image quality without utilizing radial distortion correction. Distortion is a deviation from rectilinear projection, a projection in which straight lines in a scene remain straight in an image. Radial distortion is a failure of a lens to be rectilinear.

The two-step approach as discussed above includes (1) applying a camera model to the captured image for projecting the captured image on a non-planar imaging surface and (2) applying a view synthesis for mapping the virtual image projected on to the non-planar surface to the real display image. For view synthesis, given one or more images of a specific subject taken from specific points with specific camera setting and orientations, the goal is to build a synthetic image as taken from a virtual camera having a same or different optical axis.

The proposed approach provides effective surround view and dynamic rearview mirror functions with an enhanced de-warping operation, in addition to a dynamic view synthesis for ultra-wide FOV cameras. Camera calibration as used herein refers to estimating a number of camera parameters including both intrinsic and extrinsic parameters. The intrinsic parameters include focal length, image center (or principal point), radial distortion parameters, etc. and extrinsic parameters include camera location, camera orientation, etc.

Camera models are known in the art for mapping objects in the world space to an image sensor plane of a camera to generate an image. One model known in the art is referred to as a pinhole camera model that is effective for modeling the image for narrow FOV cameras. The pinhole camera model is defined as:

$$S \underbrace{[ \begin{matrix}u \\ v \\ 1\end{matrix} ]}_{m} = [ \begin{matrix} \\ \underbrace{\begin{matrix}{f}_{u} & Y & {u}_{c} \\ 0 & {f}_{v} & {v}_{c} \\ 0 & 0 & 1\end{matrix}}_{A}\end{matrix} ] [ \begin{matrix} \\ \underbrace{\begin{matrix}{r}_{1} & {r}_{2} & {r}_{3} & t\end{matrix}}_{[ R t ]}\end{matrix} ] \underbrace{[ \begin{matrix}x \\ y \\ z \\ 1\end{matrix} ]}_{M} \qquad ( 1 )$$

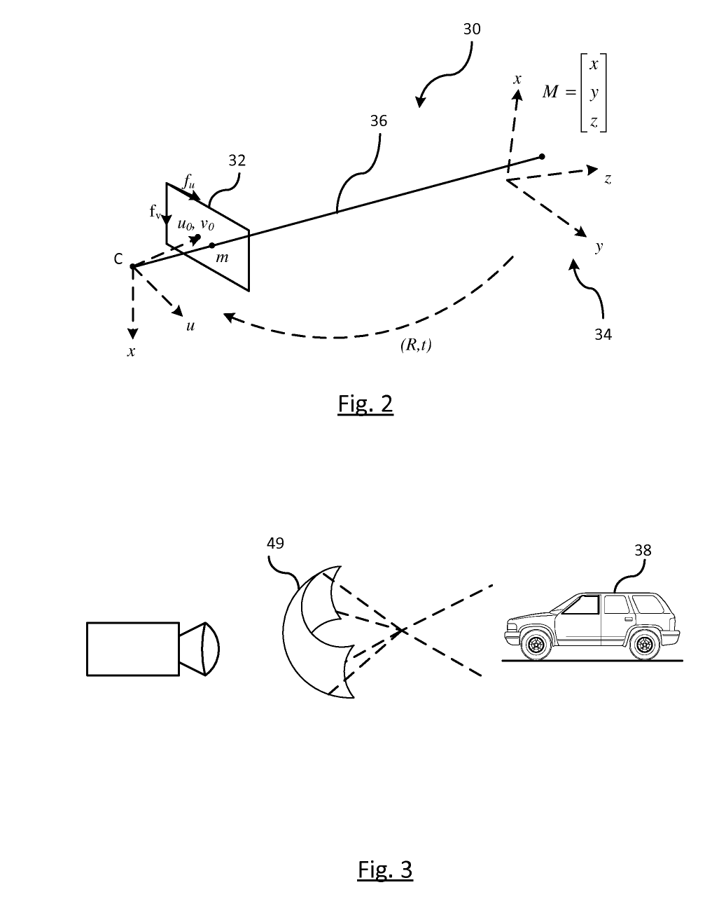

FIG. 2 is an illustration 30 for the pinhole camera model and shows a two dimensional camera image plane 32 defined by coordinates u, v, and a three dimensional object space 34 defined by world coordinates x, y, and z. The distance from a focal point C to the image plane 32 is the focal length ƒ of the camera and is defined by focal length ƒᵤ and ƒᵥ. A perpendicular line from the point C to the principal point of the image plane 32 defines the image center of the plane 32 designated by u₀, v₀. In the illustration 30, an object point M in the object space 34 is mapped to the image plane 32 at point m, where the coordinates of the image point m is u_{c}, v_{c}.

Equation (1) includes the parameters that are employed to provide the mapping of point M in the object space 34 to point min the image plane 32. Particularly, intrinsic parameters include ƒᵤ, ƒᵥ, u_{c}, v_{c} and γ and extrinsic parameters include a 3 by 3 matrix R for the camera rotation and a 3 by 1 translation vector t from the image plane 32 to the object space 34. The parameter γ represents a skewness of the two image axes that is typically negligible, and is often set to zero.

Since the pinhole camera model follows rectilinear projection which a finite size planar image surface can only cover a limited FOV range (<<180° FOV), to generate a cylindrical panorama view for an ultra-wide (˜180° FOV) fisheye camera using a planar image surface, a specific camera model must be utilized to take horizontal radial distortion into account. Some other views may require other specific camera modeling, (and some specific views may not be able to be generated). However, by changing the image plane to a non-planar image surface, a specific view can be easily generated by still using the simple ray tracing and pinhole camera model. As a result, the following description will describe the advantages of utilizing a non-planar image surface.

The rearview mirror display device 24 (shown in FIG. 1) outputs images captured by the vision-based imaging system 12. The images may be altered images that may be converted to show enhanced viewing of a respective portion of the FOV of the captured image. For example, an image may be altered for generating a panoramic scene, or an image may be generated that enhances a region of the image in the direction of which a vehicle is turning. The proposed approach as described herein models a wide FOV camera with a concave imaging surface for a simpler camera model without radial distortion correction. This approach utilizes virtual view synthesis techniques with a novel camera imaging surface modeling (e.g., light-ray-based modeling). This technique has a variety of applications of rearview camera applications that include dynamic guidelines, 360 surround view camera system, and dynamic rearview mirror feature. This technique simulates various image effects through the simple camera pin-hole model with various camera imaging surfaces. It should be understood that other models, including traditional models, can be used aside from a camera pin-hole model.

FIG. 3 illustrates a preferred technique for modeling the captured scene 38 using a non-planar image surface. Using the pin-hole model, the captured scene 38 is projected onto a non-planar image 49 (e.g., concave surface). No radial distortion correction is applied to the projected image since the image is being displayed on a non-planar surface.

A view synthesis technique is applied to the projected image on the non-planar surface for de-warping the image. In FIG. 3, image de-warping is achieved using a concave image surface. Such surfaces may include, but are not limited to, a cylinder and ellipse image surfaces. That is, the captured scene is projected onto a cylindrical like surface using a pin-hole model. Thereafter, the image projected on the cylinder image surface is laid out on the flat in-vehicle image display device. As a result, the parking space which the vehicle is attempting to park is enhanced for better viewing for assisting the driver in focusing on the area of intended travel.

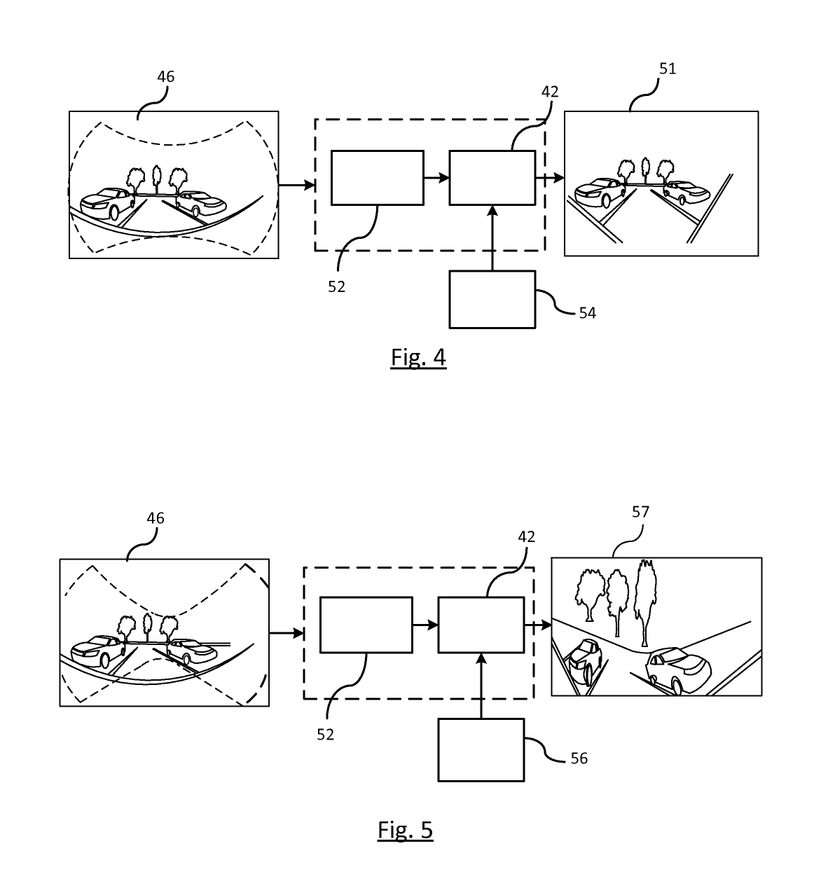

FIG. 4 illustrates a block flow diagram for applying cylinder image surface modeling to the captured scene. A captured scene is shown at block 46. Camera modeling 52 is applied to the captured scene 46. As described earlier, the camera model is preferably a pin-hole camera model, however, traditional or other camera modeling may be used. The captured image is projected on a respective surface using the pin-hole camera model. The respective image surface is a cylindrical image surface 54. View synthesis 42 is performed by mapping the light rays of the projected image on the cylindrical surface to the incident rays of the captured real image to generate a de-warped image. The result is an enhanced view of the available parking space where the parking space is centered at the forefront of the de-warped image 51.

FIG. 5 illustrates a flow diagram for utilizing an ellipse image surface model to the captured scene utilizing the pin-hole model. The ellipse image model 56 applies greater resolution to the center of the capture scene 46. Therefore, as shown in the de-warped image 57, the objects at the center forefront of the de-warped image are more enhanced using the ellipse model in comparison to FIG. 5.

Dynamic view synthesis is a technique by which a specific view synthesis is enabled based on a driving scenario of a vehicle operation. For example, special synthetic modeling techniques may be triggered if the vehicle is in driving in a parking lot versus a highway, or may be triggered by a proximity sensor sensing an object to a respective region of the vehicle, or triggered by a vehicle signal (e.g., turn signal, steering wheel angle, or vehicle speed). The special synthesis modeling technique may be to apply respective shaped models to a captured image, or apply virtual pan, tilt, or directional zoom depending on a triggered operation.

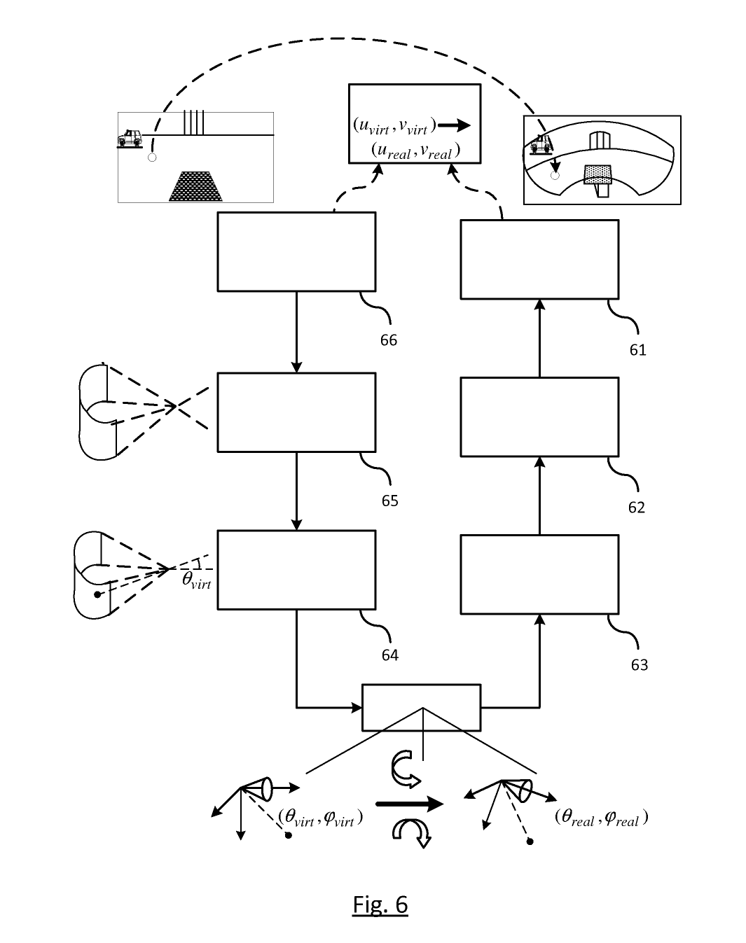

FIG. 6 illustrates a flow diagram of view synthesis for mapping a point from a real image to the virtual image. In block 61, a real point on the captured image is identified by coordinates uᵣₑₐₗ and vᵣₑₐₗ which identify where an incident ray contacts an image surface. An incident ray can be represented by the angles (θ, φ), where θ is the angle between the incident ray and an optical axis, and φ is the angle between the x axis and the projection of the incident ray on the x−y plane. To determine the incident ray angle, a real camera model is pre-determined and calibrated.

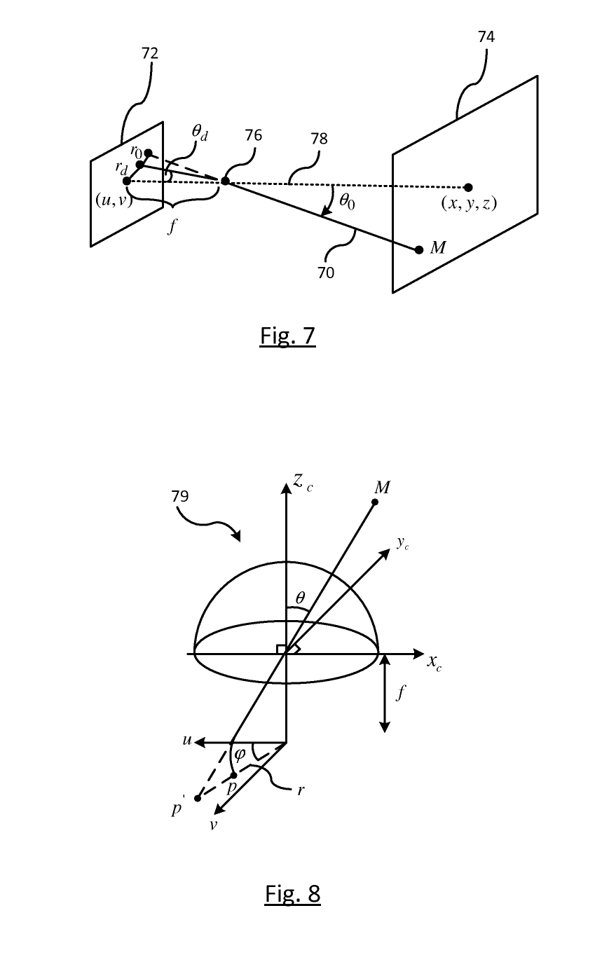

In block 62, the real camera model is defined, such as the fisheye model (r_{d}=func(θ) and φ). That is, the incident ray as seen by a real fish-eye camera view may be illustrated as follows:

$$Incident ray \to [ \begin{matrix}\begin{matrix}θ \text{:} angle between incident ray \\ and optical axis\end{matrix} \\ \begin{matrix}ϕ \text{:} angle between {x}_{c 1} and \\ incident ray projection on \\ the {x}_{c 1} - {y}_{c 1} plane\end{matrix}\end{matrix} ] \to [ \begin{matrix}{r}_{d} = func ( θ ) \\ ϕ\end{matrix} ] \to [ \begin{matrix}{u}_{c 1} = {r}_{d} \cdot cos ( ϕ ) \\ {v}_{c 1} = {r}_{d} \cdot sin ( ϕ )\end{matrix} ] \qquad ( 2 )$$

where x_{c1}, y_{c1}, and z_{c1} are the camera coordinates where z_{c1} is a camera/lens optical axis that points out the camera, and where u_{c1} represents uᵣₑₐₗ and v_{c1} represents vᵣₑₐₗ. A radial distortion correction model is shown in FIG. 7. The radial distortion model, represented by equation (3) below, sometimes referred to as the Brown-Conrady model, that provides a correction for non-severe radial distortion for objects imaged on an image plane 72 from an object space 74. The focal length ƒ of the camera is the distance between point 76 and the image center where the lens optical axis intersects with the image plane 72. In the illustration, an image location r₀ at the intersection of line 70 and the image plane 72 represents a virtual image point m₀ of the object point M if a pinhole camera model is used. However, since the camera image has radial distortion, the real image point m is at location r_{d}, which is the intersection of the line 78 and the image plane 72. The values r₀ and r_{d} are not points, but are the radial distance from the image center u₀, v₀ to the image points m₀ and m.

r_{d}=r₀(1+k₁·r₀²+k₂·r₀⁴+k₂·r₀⁶+ . . . (3)

The point r₀ is determined using the pinhole model discussed above and includes the intrinsic and extrinsic parameters mentioned. The model of equation (3) is an even order polynomial that converts the point r₀ to the point r_{d} in the image plane 72, where k is the parameters that need to be determined to provide the correction, and where the number of the parameters k define the degree of correction accuracy. The calibration process is performed in the laboratory environment for the particular camera that determines the parameters k. Thus, in addition to the intrinsic and extrinsic parameters for the pinhole camera model, the model for equation (3) includes the additional parameters k to determine the radial distortion. The non-severe radial distortion correction provided by the model of equation (3) is typically effective for wide FOV cameras, such as 135° FOV cameras. However, for ultra-wide FOV cameras, i.e., 180° FOV, the radial distortion is too severe for the model of equation (3) to be effective. In other words, when the FOV of the camera exceeds some value, for example, 140°-150°, the value r₀ goes to infinity when the angle θ approaches 90°. For ultra-wide FOV cameras, a severe radial distortion correction model shown in equation (4) has been proposed in the art to provide correction for severe radial distortion.

FIG. 8 illustrates a fisheye model which shows a dome to illustrate the FOV. This dome is representative of a fisheye lens camera model and the FOV that can be obtained by a fisheye model which is as large as 180 degrees or more. A fisheye lens is an ultra wide-angle lens that produces strong visual distortion intended to create a wide panoramic or hemispherical image. Fisheye lenses achieve extremely wide angles of view by forgoing producing images with straight lines of perspective (rectilinear images), opting instead for a special mapping (for example: equisolid angle), which gives images a characteristic convex non-rectilinear appearance This model is representative of severe radial distortion due which is shown in equation (4) below, where equation (4) is an odd order polynomial, and includes a technique for providing a radial correction of the point r₀ to the point r_{d} in the image plane 79. As above, the image plane is designated by the coordinates u and v, and the object space is designated by the world coordinates x, y, z. Further, θ is the incident angle between the incident ray and the optical axis. In the illustration, point ρ′ is the virtual image point of the object point M using the pinhole camera model, where its radial distance r₀ may go to infinity when θ approaches 90°. Point p at radial distance r is the real image of point M, which has the radial distortion that can be modeled by equation (4).

The values q in equation (4) are the parameters that are determined. Thus, the incidence angle θ is used to provide the distortion correction based on the calculated parameters during the calibration process.

r_{d}=q₁·θ₀+q₂·θ₀³+q₃·θ₀⁵+ . . . (4)

Various techniques are known in the art to provide the estimation of the parameters k for the model of equation (3) or the parameters q for the model of equation (4). For example, in one embodiment a checker board pattern is used and multiple images of the pattern are taken at various viewing angles, where each corner point in the pattern between adjacent squares is identified. Each of the points in the checker board pattern is labeled and the location of each point is identified in both the image plane and the object space in world coordinates. The calibration of the camera is obtained through parameter estimation by minimizing the error distance between the real image points and the reprojection of 3D object space points.

In block 63, a real incident ray angle (θᵣₑₐₗ) and (φᵣₑₐₗ) are determined from the real camera model. The corresponding incident ray will be represented by a (θᵣₑₐₗ, φᵣₑₐₗ).

In block 64, a virtual incident ray angle θᵥᵢᵣₜ and corresponding φᵥᵢᵣₜ is determined. If there is no virtual tilt and/or pan, then (θᵥᵢᵣₜ, φᵥᵢᵣₜ) will be equal to (θᵣₑₐₗ, φᵣₑₐₗ). If virtual tilt and/or pan are present, then adjustments must be made to determine the virtual incident ray. Discussion of the virtual incident ray will be discussed in detail later.

Referring again to FIG. 6, in block 65, once the incident ray angle is known, then view synthesis is applied by utilizing a respective camera model (e.g., pinhole model) and respective non-planar imaging surface (e.g., cylindrical imaging surface).

In block 66, the virtual incident ray that intersects the non-planar surface is determined in the virtual image. The coordinate of the virtual incident ray intersecting the virtual non-planar surface as shown on the virtual image is represented as (uᵥᵢᵣₜ, vᵥᵢᵣₜ). As a result, a mapping of a pixel on the virtual image (uᵥᵢᵣₜ, vᵥᵢᵣₜ) corresponds to a pixel on the real image (uᵣₑₐₗ, vᵣₑₐₗ).

It should be understood that while the above flow diagram represents view synthesis by obtaining a pixel in the real image and finding a correlation to the virtual image, the reverse order may be performed when utilizing in a vehicle. That is, every point on the real image may not be utilized in the virtual image due to the distortion and focusing only on a respective highlighted region (e.g., cylindrical/elliptical shape). Therefore, if processing takes place with respect to these points that are not utilized, then time is wasted in processing pixels that are not utilized. Therefore, for an in-vehicle processing of the image, the reverse order is performed. That is, a location is identified in a virtual image and the corresponding point is identified in the real image. The following describes the details for identifying a pixel in the virtual image and determining a corresponding pixel in the real image.

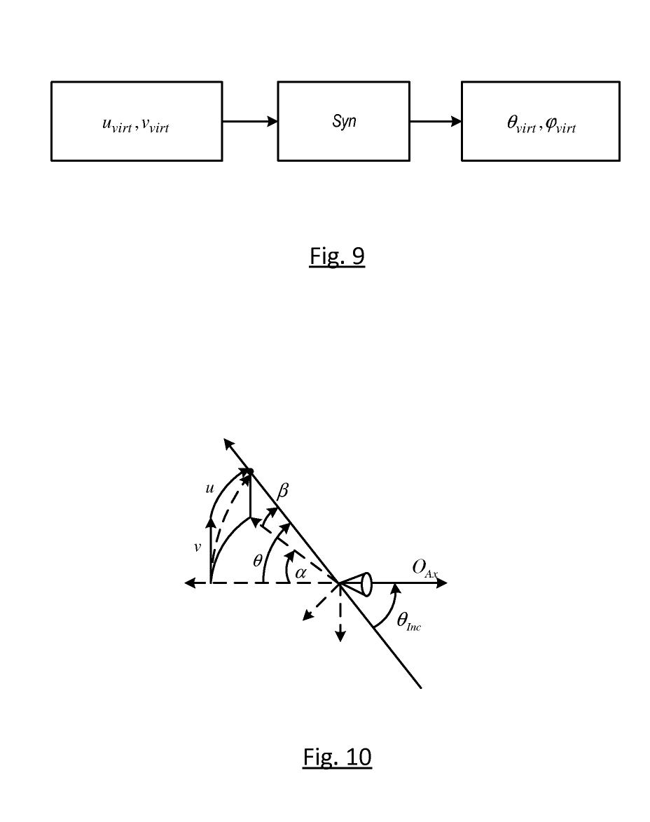

FIG. 9 illustrates a block diagram of the first step for obtaining a virtual coordinate (uᵥᵢᵣₜ, vᵥᵢᵣₜ) and applying view synthesis for identifying virtual incident angles (θᵥᵢᵣₜ, φᵥᵢᵣₜ). FIG. 10 represents an incident ray projected onto a respective cylindrical imaging surface model. The horizontal projection of incident angle θ is represented by the angle α. The formula for determining angle α follows the equidistance projection as follows:

$$\frac{{u}_{virt} - {u}_{0}}{{f}_{u}} = α \qquad ( 5 )$$

where uᵥᵢᵣₜ is the virtual image point u-axis (horizontal) coordinate, ƒᵤ is the u direction (horizontal) focal length of the camera, and u₀ is the image center u-axis coordinate.

Next, the vertical projection of angle θ is represented by the angle β. The formula for determining angle β follows the rectilinear projection as follows:

$$\frac{{v}_{virt} - {v}_{0}}{{f}_{v}} = tan β \qquad ( 6 )$$

where vᵥᵢᵣₜ is the virtual image point v-axis (vertical) coordinate, ƒᵥ is the v direction (vertical) focal length of the camera, and v₀ is the image center v-axis coordinate.

The incident ray angles can then be determined by the following formulas:

$$\{ \begin{matrix}{θ}_{virt} = arccos ( cos ( α ) \cdot cos ( β ) ) \\ {ϕ}_{virt} = arctan ( sin ( α ) \cdot tan ( β ) )\end{matrix} \} \qquad ( 7 )$$

As described earlier, if there is no pan or tilt between the optical axis of the virtual camera and the real camera, then the virtual incident ray (θᵥᵢᵣₜ, φᵥᵢᵣₜ) and the real ray (θᵣₑₐₗ, φᵣₑₐₗ) are equal. If pan and/or tilt are present, then compensation must be made to correlate the projection of the virtual incident ray and the real incident ray.

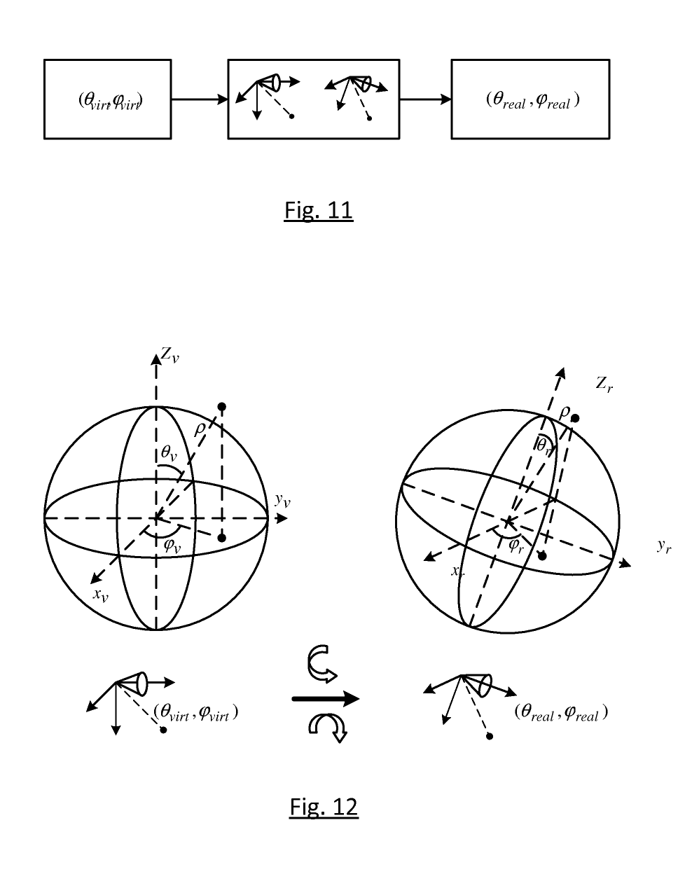

FIG. 11 illustrates the block diagram conversion from virtual incident ray angles to real incident ray angles when virtual tilt and/or pan are present. Since optical axis of the virtual cameras will be focused toward the sky and the real camera will be substantially horizontal to the road of travel, a difference is the axes requires a tilt and/or pan rotation operation.

FIG. 12 illustrates a comparison between axes changes from virtual to real due to virtual pan and/or tilt rotations. The incident ray location does not change, so the correspondence virtual incident ray angles and the real incident ray angle as shown is related to the pan and tilt. The incident ray is represented by the angles (θ, φ), where θ is the angle between the incident ray and the optical axis (represented by the z axis), and φ is the angle between x axis and the projection of the incident ray on the x−y plane.

For each determined virtual incident ray (θᵥᵢᵣₜ, φᵥᵢᵣₜ), any point on the incident ray can be represented by the following matrix:

$${P}_{virt} = ρ \cdot [ \begin{matrix}sin ( {θ}_{virt} ) \cdot cos ( {θ}_{virt} ) \\ sin ( {θ}_{virt} ) \cdot sin ( {θ}_{virt} ) \\ cos ( {θ}_{virt} )\end{matrix} ] , \qquad ( 8 )$$

where ρ is the distance of the point form the origin.

The virtual pan and/or tilt can be represented by a rotation matrix as follows:

$${R}_{rot} = {R}_{tilt} \cdot {R}_{pan} = [ \begin{matrix}1 & 0 & 0 \\ 0 & cos ( β ) & sin ( β ) \\ 0 & - sin ( β ) & cos ( β )\end{matrix} ] \cdot [ \begin{matrix}cos ( α ) & 0 & - sin ( α ) \\ 0 & 1 & 0 \\ sin ( α ) & 0 & cos ( α )\end{matrix} ] \qquad ( 9 )$$

where α is the pan angle, and β is the tilt angle.

After the virtual pan and/or tilt rotation is identified, the coordinates of a same point on the same incident ray (for the real) will be as follows:

$${P}_{real} = {R}_{rot} \cdot {R}_{virt} = ρ \cdot {R}_{rot} [ \begin{matrix}sin ( {θ}_{virt} ) \cdot cos ( {θ}_{virt} ) \\ sin ( {θ}_{virt} ) \cdot sin ( {θ}_{virt} ) \\ cos ( {θ}_{virt} )\end{matrix} ] = ρ [ \begin{matrix}{a}_{1} \\ {a}_{2} \\ {a}_{3}\end{matrix} ] , \qquad ( 10 )$$

The new incident ray angles in the rotated coordinates system will be as follows:

$${θ}_{real} = arctan ( \frac{\sqrt{{a}_{1}^{2} + {a}_{2}^{2}}}{{a}_{3}} ) , φ = real = arctan ( \frac{{a}_{2}}{{a}_{1}} ) . \qquad ( 11 )$$

As a result, a correspondence is determined between (θᵥᵢᵣₜ, φᵥᵢᵣₜ) and (θᵣₑₐₗ, φᵣₑₐₗ) when tilt and/or pan is present with respect to the virtual camera model. It should be understood that that the correspondence between (θᵥᵢᵣₜ, φᵥᵢᵣₜ) and (θᵣₑₐₗ, φᵣₑₐₗ) is not related to any specific point at distance ρ on the incident ray. The real incident ray angle is only related to the virtual incident ray angles (θᵥᵢᵣₜ, φᵥᵢᵣₜ) and virtual pan and/or tilt angles α and β.

Once the real incident ray angles are known, the intersection of the respective light rays on the real image may be readily determined as discussed earlier. The result is a mapping of a virtual point on the virtual image to a corresponding point on the real image. This process is performed for each point on the virtual image for identifying corresponding point on the real image and generating the resulting image.

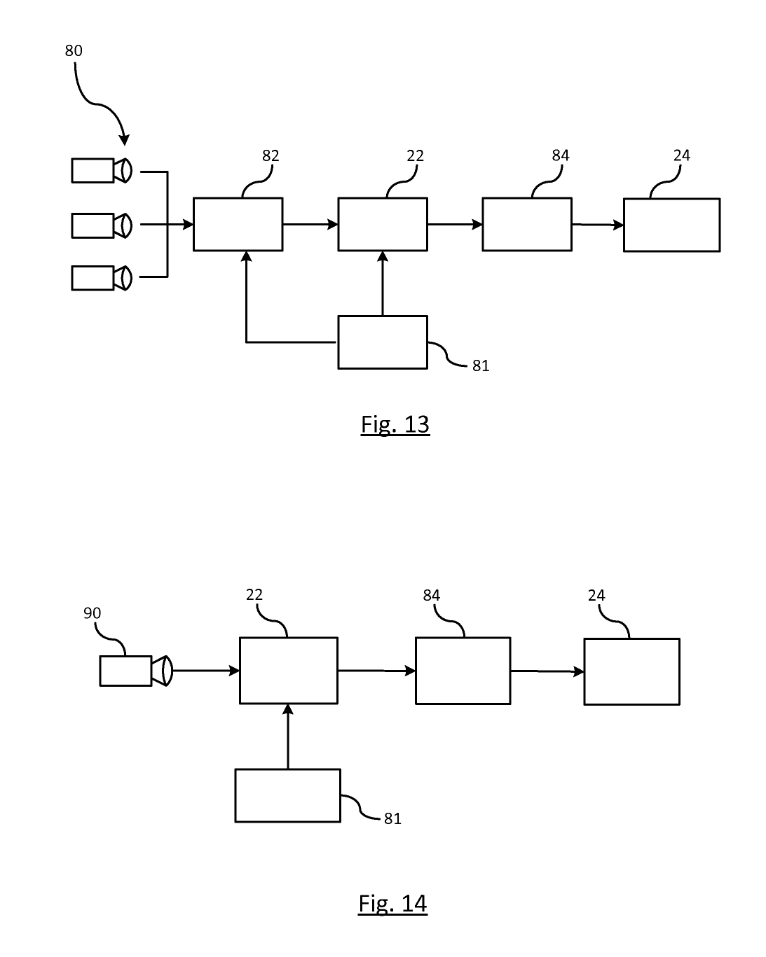

FIG. 13 illustrates a block diagram of the overall system diagrams for displaying the captured images from one or more image capture devices on the rearview mirror display device. A plurality of image capture devices are shown generally at 80. The plurality of image capture devices 80 includes at least one front camera, at least one side camera, and at least one rearview camera.

The images by the image capture devices 80 are input to a camera switch. The plurality of image capture devices 80 may be enabled based on the vehicle operating conditions 81, such as vehicle speed, turning a corner, or backing into a parking space. The camera switch 82 enables one or more cameras based on vehicle information 81 communicated to the camera switch 82 over a communication bus, such as a CAN bus. A respective camera may also be selectively enabled by the driver of the vehicle.

The captured images from the selected image capture device(s) are provided to a processing unit 22. The processing unit 22 processes the images utilizing a respective camera model as described herein and applies a view synthesis for mapping the capture image onto the display of the rearview mirror device 24.

A mirror mode button 84 may be actuated by the driver of the vehicle for dynamically enabling a respective mode associated with the scene displayed on the rearview mirror device 24. Three different modes include, but are not limited to, (1) dynamic rearview mirror with review cameras; (2) dynamic mirror with front-view cameras; and (3) dynamic review mirror with surround view cameras.

Upon selection of the mirror mode and processing of the respective images, the processed images are provided to the rearview image device 24 where the images of the captured scene are reproduced and displayed to the driver of the vehicle via the rearview image display device 24. It should be understood that any of the respective cameras may be used to capture the image for conversion to a virtual image for scene brightness analysis.

FIG. 14 illustrates an example of a block diagram of a dynamic rearview mirror display imaging system using a single camera. The dynamic rearview mirror display imaging system includes a single camera 90 having wide angle FOV functionality. The wide angle FOV of the camera may be greater than, equal to, or less than 180 degrees viewing angle.

If only a single camera is used, camera switching is not required. The captured image is input to the processing unit 22 where the captured image is applied to a camera model. The camera model utilized in this example includes an ellipse camera model; however, it should be understood that other camera models may be utilized. The projection of the ellipse camera model is meant to view the scene as though the image is wrapped about an ellipse and viewed from within. As a result, pixels that are at the center of the image are viewed as being closer as opposed to pixels located at the ends of the captured image. Zooming in the center of the image is greater than at the sides.

The processing unit 22 also applies a view synthesis for mapping the captured image from the concave surface of the ellipse model to the flat display screen of the rearview mirror.

The mirror mode button 84 includes further functionality that allows the driver to control other viewing options of the rearview mirror display 24. The additional viewing options that may be selected by driver includes: (1) Mirror Display Off; (2) Mirror Display On With Image Overlay; and (3) Mirror Display On Without Image Overlay.

“Mirror Display Off” indicates that the image captured by the capture image device that is modeled, processed, displayed as a de-warped image is not displayed onto the rearview mirror display device. Rather, the rearview mirror functions identical as a mirror displaying only those objects captured by the reflection properties of the mirror.

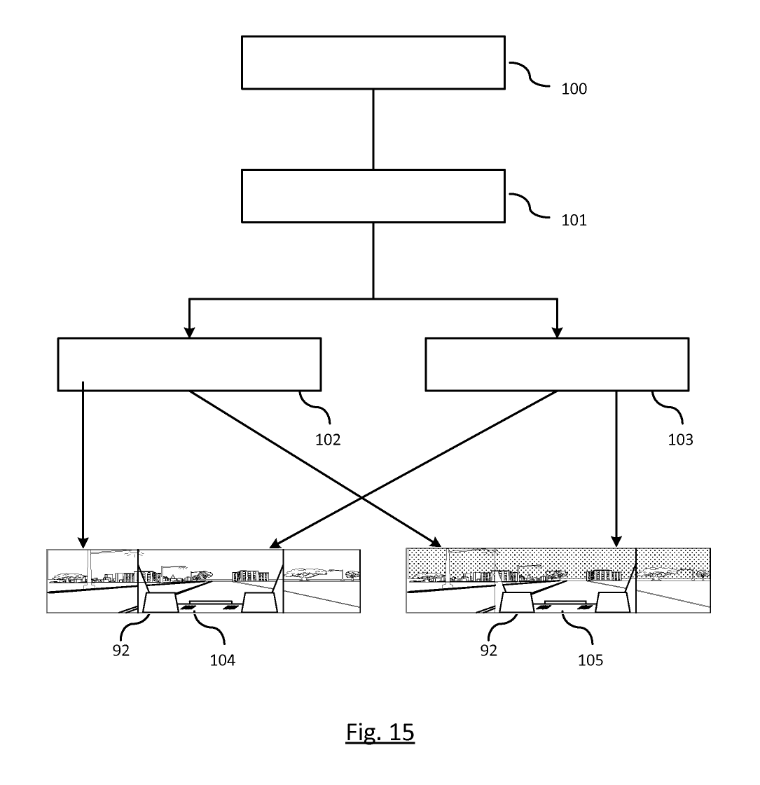

The “Mirror Display On With Image Overlay” indicates that the captured image by the capture image device that is modeled, processed, and projected as a de-warped image is displayed on the image capture device 24 illustrating the wide angle FOV of the scene. Moreover, an image overlay 92 (shown in FIG. 15) is projected onto the image display of the rearview mirror 24. The image overlay 92 replicates components of the vehicle (e.g., head rests, rear window trim, c-pillars) that would typically be seen by a driver when viewing a reflection through the rearview mirror having ordinary reflection properties. This image overlay 92 assist the driver in identifying relative positioning of the vehicle with respect to the road and other objects surrounding the vehicle. The image overlay 92 is preferably translucent or thin sketch lines representing the vehicle key elements to allow the driver to view the entire contents of the scene unobstructed.

The “Mirror Display On Without Image Overlay” displays the same captured images as described above but without the image overlay. The purpose of the image overlay is to allow the driver to reference contents of the scene relative to the vehicle; however, a driver may find that the image overlay is not required and may select to have no image overlay in the display. This selection is entirely at the discretion of the driver of the vehicle.

Based on the selection made to the mirror button mode 84, the appropriate image is presented to the driver via the rearview mirror in block 24. It should be understood that if more than one camera is utilized, such as a plurality of narrow FOV cameras, where each of the images must be integrated together, then image stitching may be used. Image stitching is the process of combining multiple images with overlapping regions of the images FOV for producing a segmented panoramic view that is seamless. That is, the combined images are combined such that there are no noticeable boundaries as to where the overlapping regions have been merged. After image stitching has been performed, the stitched image is input to the processing unit for applying camera modeling and view synthesis to the image.

In systems were just an image is reflected by a typical rearview mirror or a captured image is obtained where dynamic enhancement is not utilized such as a simple camera with no fisheye or a camera having a narrow FOV, objects that are possible a safety issue or could by on a collision with the vehicle are not captured in the image. Other sensors on the vehicle may in fact detect such objects, but displaying a warning and identifying the image in the object is an issue. Therefore, by utilizing a captured image and utilizing a dynamic display where a wide FOV is obtained either by a fisheye lens, image stitching, or digital zoom, an object can be illustrated on the image. Moreover, symbols such a parking assist symbols and object outlines for collision avoidance may be overlaid on the object.

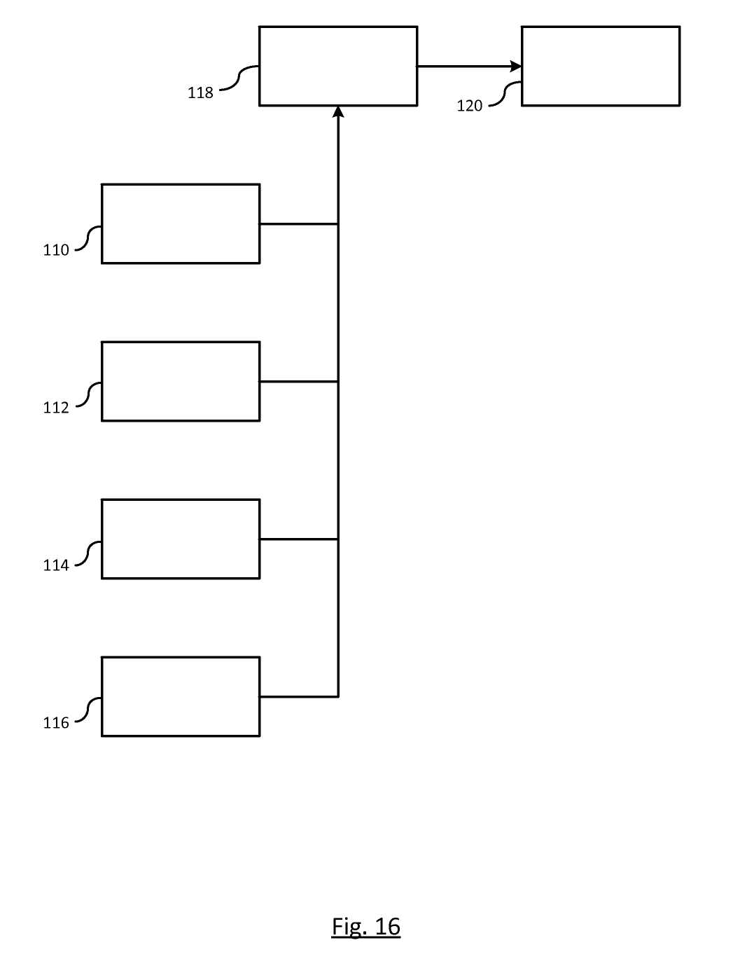

FIG. 16 illustrates a flowchart of first embodiment for identifying objects on the dynamic rearview mirror display device. While the embodiments discussed herein describe the display of the image on the rearview mirror device, it is understood that the display device is not limited to the rearview mirror and may include any other display device in the vehicle. Blocks 110-116 represent various sensing devices for sensing objects exterior of the vehicle, such as vehicles, pedestrians, bikes, and other moving and stationary objects. For example, block 110 is a side blind zone alert sensor (SBZA) sensing system for sensing objects in a blind spot of the vehicle; block 112 is a parking assist (PA) ultrasonic sensing system for sensing pedestrians; block 44 is a rear cross traffic alert (RTCA) system for detecting a vehicle in a rear crossing path that is transverse to the driven vehicle; and block 116 is a rearview camera for capturing scenes exterior of the vehicle. In FIG. 16, an image is captured and is displayed on the rearview image display device. Any of the objects detected by any of the systems shown in blocks 110-116 are cooperatively analyzed and identified. Any of the alert symbols utilized by any of the sensing systems 110-114 may be processed and those symbols may be overlaid on the dynamic image in block 129. The dynamic image and the overlay symbols are then displayed on the rearview display device in block 120.

In typical systems, as shown in FIG. 17, a rear crossing object approaching as detected by the RCTA system is not yet seen on an image captured by a narrow FOV imaging device. However, the object that cannot be seen in the image is identified by the RCTA symbol 122 for identifying an object identified by one of the sensing systems but is not in the image yet.

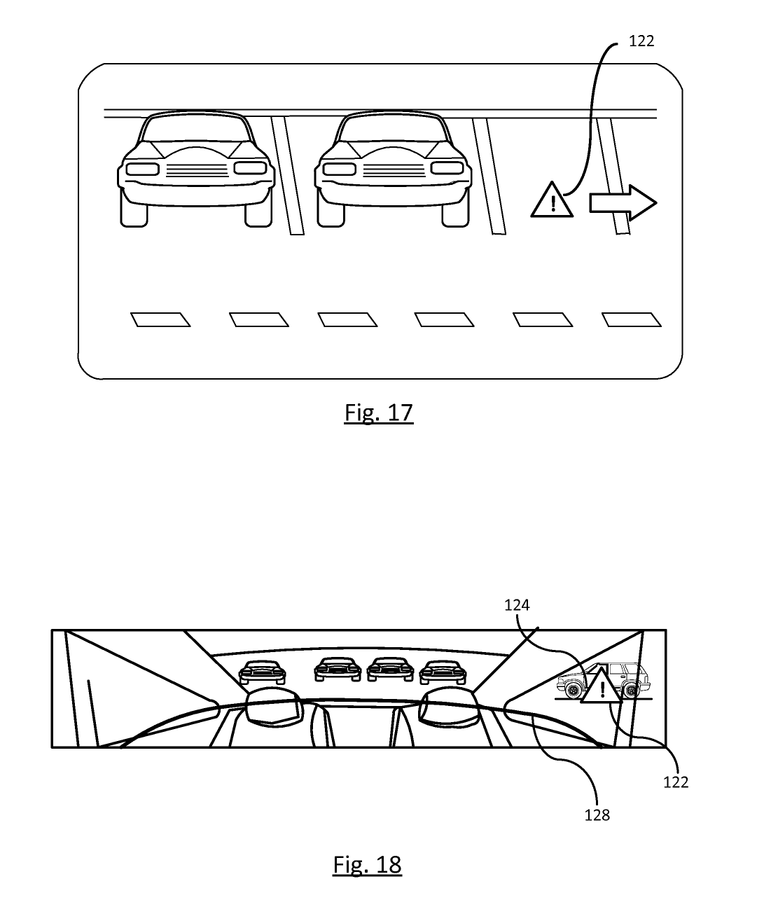

FIG. 18 illustrates a system utilizing a dynamic rearview display. In FIG. 18, a vehicle 124 is captured approaching from the right side of the captured image. Objects are captured by the imaging device using a wide FOV captured image or the image may be stitched together using multiple images captured by more than one image capture device. Due to the distortion of the image at the far ends of the image, in addition to the speed of the vehicle 124 as it travels along the road of travel that is transverse to the travel path of the driven vehicle, the vehicle 124 may not be readily noticeable or the speed of the vehicle may not be readily predictable by the driver. In cooperation with the RCTA system, to assist the driver in identifying the vehicle 124 that could be on a collision course if both vehicles were to proceed into the intersection, an alert symbol 126 is overlaid around the vehicle 124 which has been perceived by the RCTA system as a potential threat. Other vehicle information may be included as part of the alert symbol that includes, vehicle speed, time-to-collision, course heading may be overlaid around the vehicle 124. The symbol 122 is overlaid across the vehicle 124 or other object as may be required to provide notification to the driver. The symbol does not need to identify the exact location or size of the object, but rather just provide notification of the object in the image to the driver.

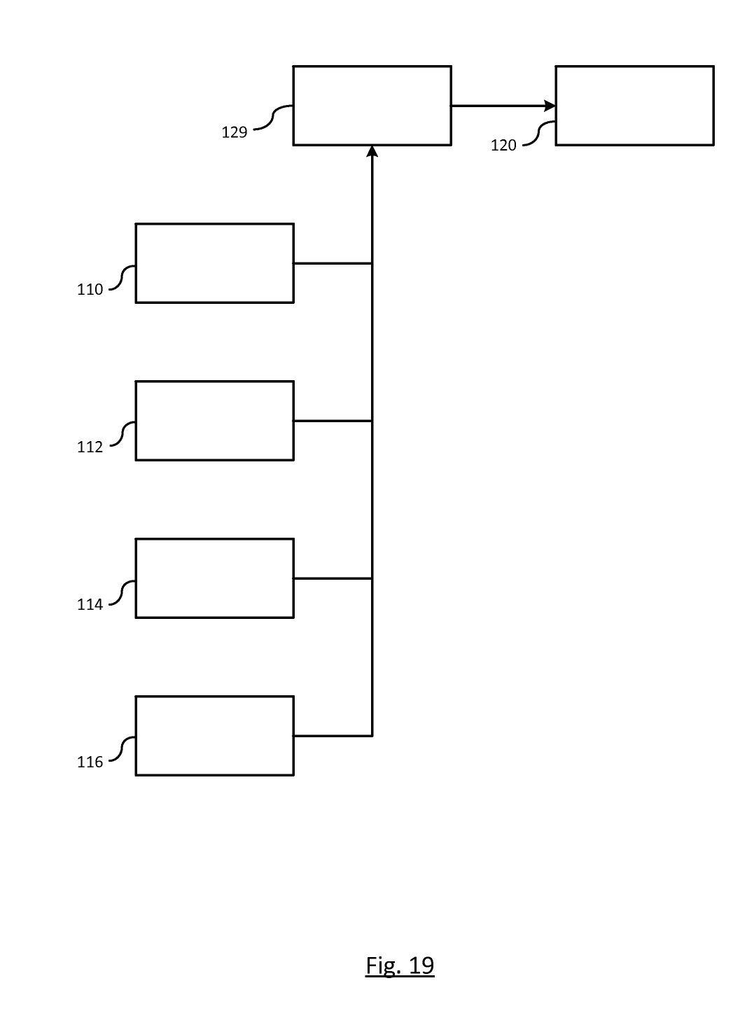

FIG. 19 illustrates a flowchart of a second embodiment for identifying objects on the rearview mirror display device. Similar reference numbers will be utilized throughout for already introduced devices and systems. Blocks 110-116 represent various sensing devices such as SBZA, PA, RTCA, and a rearview camera. In block 129, a processing unit provides an object overlay onto the image. The object overlay is an overlay that identifies both the correct location and size of an object as opposed to just placing a same sized symbol over the object as illustrated in FIG. 18. In block 120, the rearview display device displays the dynamic image with the object overlay symbols and collective image is then displayed on the rearview display device in block 120.

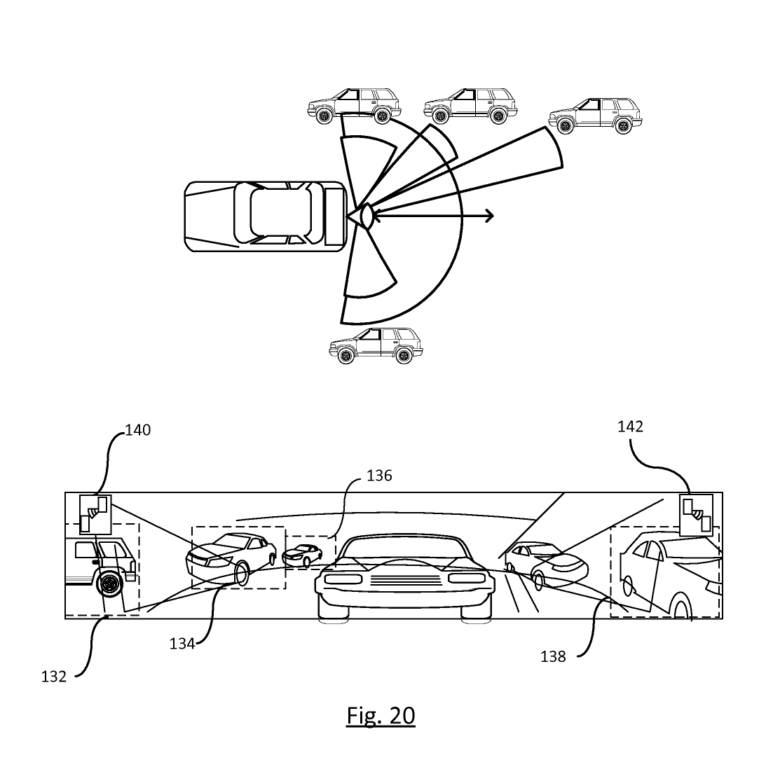

FIG. 20 is an illustration of a dynamic image displayed on the dynamic rearview mirror device. Object overlays 132-138 identify vehicles proximate to the driven vehicle that have been identified by one of the sensing systems that may be a potential collision to a driven vehicle if a driving maneuver is made and the driver of the driven vehicle is not aware of the presence of any of those objects. As shown, each object overlay is preferably represented as a rectangular box having four corners. Each of the corners designate a respective point. Each point is positioned so that when the rectangle is generated, the entire vehicle is properly positioned within the rectangular shape of the object overlay. As a result, the size of the rectangular image overlay assists the driver in identifying not only the correct location of the object but provides awareness as to the relative distance to the driven vehicle. That is, for objects that are closer to the driven vehicle, the image overly such as objects 132 and 134 will be larger, whereas, for objects that are further away from the driven vehicle, the image overlay such as object 136 will appear smaller. Moreover, redundant visual confirmation can be used with the image overlay to generate awareness condition of an object. For example, awareness notification symbols, such as symbols 140 and 142, can be displayed cooperatively with the object overlays 132 and 138, respectively, to provide a redundant warning. In this example, symbols 140 and 142 provide further details as to why the object is being highlighted and identified (e.g., blind spot detection).

Image overlay 138 generates a vehicle boundary of the vehicle. Since the virtual image is generated less any of only the objects and scenery exterior of the vehicle, the virtual image captured will not capture any exterior trim components of the vehicle. Therefore, image overlay 138 is provided that generates a vehicle boundary as to where the boundaries of the vehicle would be located had they been shown in the captured image.

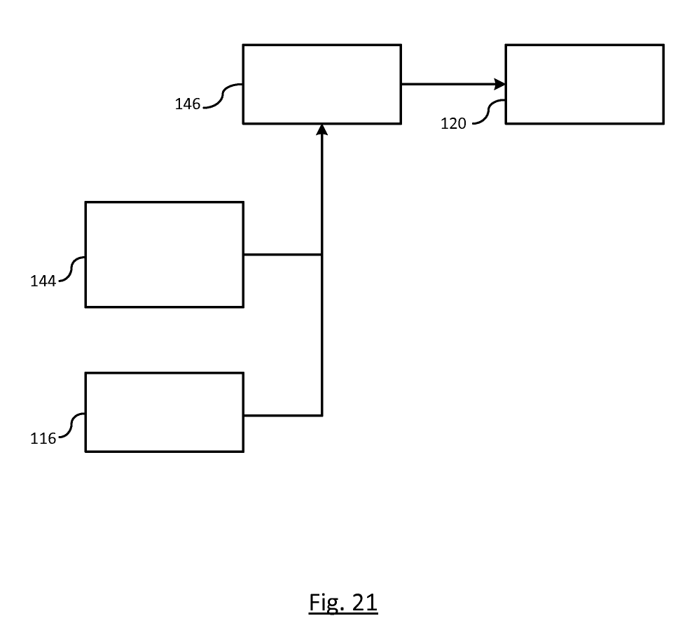

FIG. 21 illustrates a flowchart of third embodiment for identifying objects on the rearview mirror display device by estimating a time to collision base on an inter-frame object size and location expansion of an object overlay, and illustrate the warning on the dynamic rearview display device. In block 116, images are captured by an image capture device.

In block 144, various systems are used to identify objects captured in the captured image. Such objects include, but not limited to, vehicles from devices described herein, lanes of the road based on lane centering systems, pedestrians from pedestrian awareness systems, and poles or obstacles from various sensing systems/devices. A vehicle detection system estimates the time to collision herein. The time to collision and object size estimation may be determined using an image based approach or may be determined using a point motion estimation in the image plane, which will be described in detail later.

In block 146, the objects with object overlay are generated along with the time to collision for each object.

In block 120, the results are displayed on the dynamic rearview display mirror.

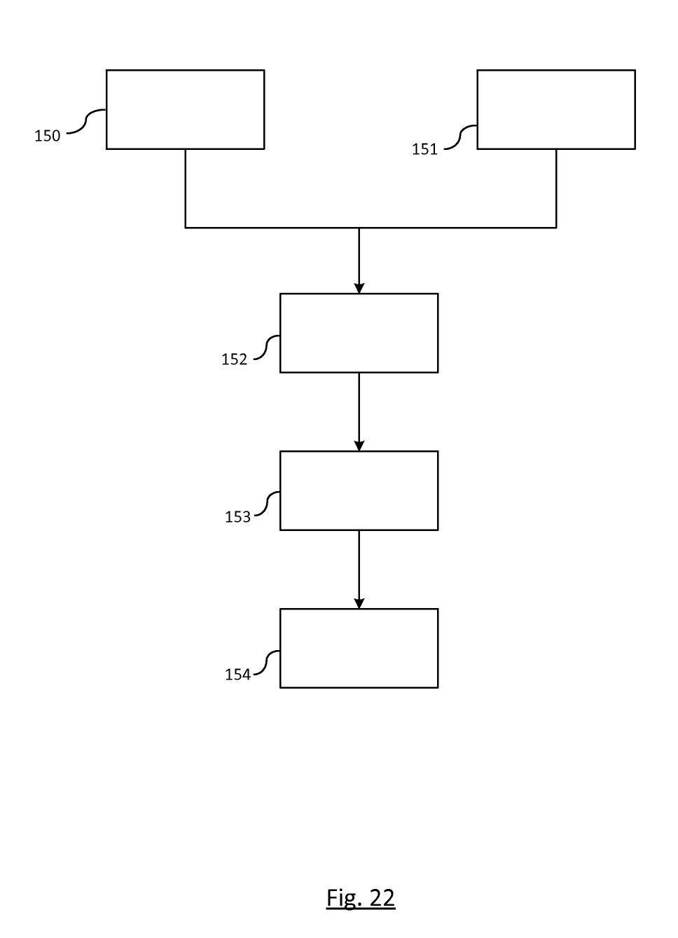

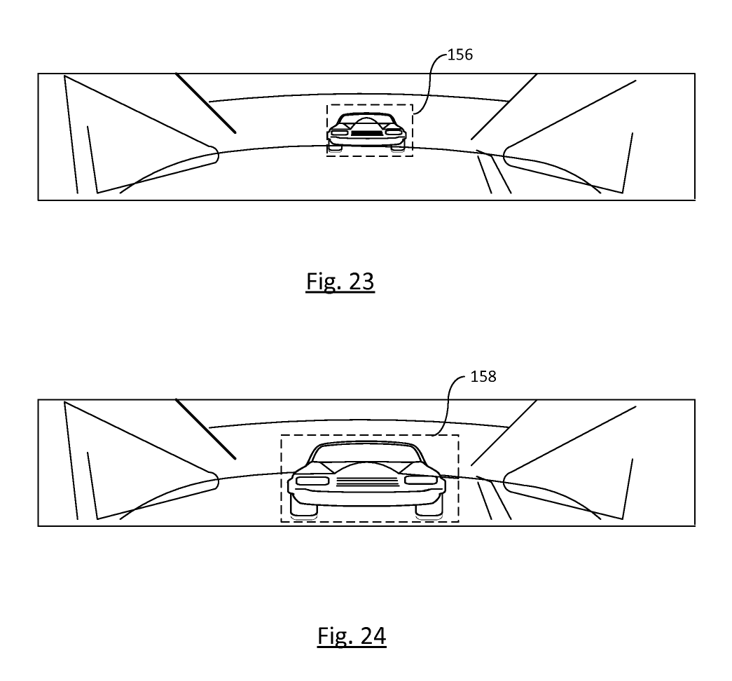

FIG. 22 is a flowchart of the time to collision and image size estimation approach as described in block 144 of FIG. 21. In block 150, an image is generated and an object is detected at time t−1. The captured image and image overlay is shown in FIG. 23 at 156. In block 151, an image is generated and the object is detected at time t. The captured image and image overlay is shown in FIG. 24 at block 158.

In block 152, the object size, distance, and vehicle coordinate is recorded. This is performed by defining a window overlay for the detected object (e.g., the boundary of the object as defined by the rectangular box). The rectangular boundary should encase the each element of the vehicle that can be identified in the captured image. Therefore, the boundaries should be close to those outermost exterior portions of the vehicle without creating large gaps between an outermost exterior component of the vehicle and the boundary itself.

To determine an object size, an object detection window is defined. This can be determined by estimating the following parameters:

def:winₜ^{det}:(uWₜ,vHₜ,vBₜ): object detection window size and location (on image) at time t

where
uWₜ: detection—window width, vHₜ: detection—window height, and vBₜ: detection—window bottom.
Next, the object size and distance represented as vehicle coordinates is estimated by the following parameters:

def:xₜ=(wₜ⁰,hₜ^{o},dₜ^{o}) is the object size and distance (observed) in vehicle coordinates

where wₜ^{o} is the object width(observed), hₜ^{o} is the object height(observed), and dₜ^{o} is the object distance(observed) at time t.
Based on camera calibration, the (observed) object size and distance Xₜ can be determined from the in-vehicle detection window size and location winₜ^{det} as represented by the following equation:

$${win}_{t}^{det} \text{:} ( {uW}_{t} , {vW}_{t} , {vB}_{t} ) {\to }^{CamCalib} {X}_{t} \text{:} ( {w}_{t}^{o} , {h}_{t}^{o} , {d}_{t}^{o} )$$

In block 153, the object distance and relative speed of the object is calculated as components in Yₜ. In this step, the output Yₜ is determined which represents the estimated object parameters (size, distance, velocity) at time t. This is represented by the following definition:

def:Yₜ=(wₜ^{e},hₜ^{e},dₜ^{e},vₜ)

where wₜ^{e}, hₜ^{e}, dₜ^{e} are estimated object size and distance,
and vₜ is the object relative speed at time t.
Next, a model is used to estimate object parameters and a time-to-collision (TTC) and is represented by the following equation:

Yₜ=ƒ(x₁,xₜ₋₁,xₜ₋₂, . . . Xₜ₋ₙ)

A more simplified example of the above function ƒ can be represented as follows:

$$object size \text{:} {w}_{t}^{e} = \frac{{\sum }_{i = 0}^{n} {w}_{t - i}^{o}}{n + 1} , {h}_{t}^{e} = \frac{{\sum }_{i = 0}^{n} {h}_{t - i}^{o}}{n + 1} , \\ object distance \text{:} {d}_{t}^{e} = {d}_{t}^{o}$$

$$object relative speed \text{:} {v}_{t} = \frac{Δ d}{Δ t} = ( {d}_{t}^{e} - {d}_{t - 1}^{e} ) / Δ t$$

In block 154, the time to collision is derived using the above formulas which is represented by the following formula:

TTC:TTCₜ=dₜ^{e}/vₜ

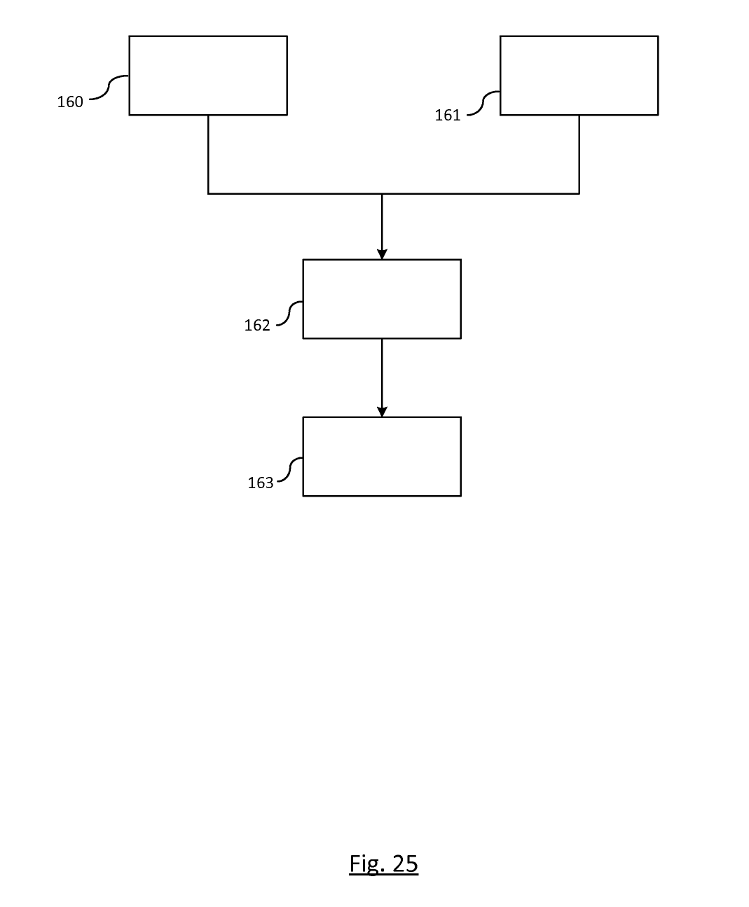

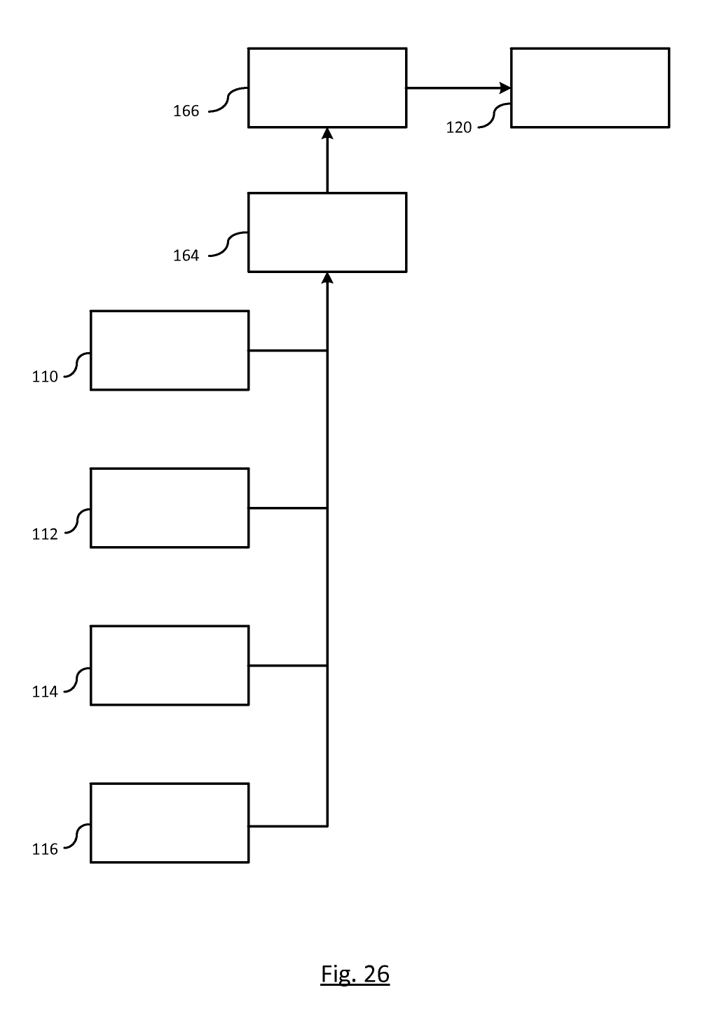

FIG. 25 is a flowchart of the time to collision estimation approach through point motion estimation in the image plane as described in FIG. 21. In block 160, an image is generated and an object size and point location is detected at time t−1. The captured image and image overlay is shown generally by 156 in FIG. 23. In block 161, an image is generated and an object size and point location is detected at time t. The captured image and image overlay is shown generally by 158 in FIG. 24.

In block 162, changes to the object size and to the object point location are determined. By comparing where an identified point in a first image is relative to the same point in another captured image where temporal displacement has occurred, the relative change in the location using the object size can be used to determine the time to collision.

In block 163, the time to collision is determined is based on the occupancy of the target in the majority of the screen height.

To determine the change in height and width and corner points of the object overlay boundary, the following technique is utilized. The following parameters are defined:

wₜ is the object width at time t,

hₜ is the object height at time t,

pₜⁱ is the corner points, i=1, 2, 3, or 4 at time t.

The changes to the parameters based on a time lapse is represented by the following equations:

Δwₜ=wₜ−wₜ₋₁,

Δhₜ=hwₜ−hₜ₋₁,

Δx(pₜⁱ)=x(pₜⁱ)−x(pₜ₋₁ⁱ),Δy(pₜⁱ)=y(pₜⁱ)−y(pₜ₋₁ⁱ)

where

wₜ=0.5*(x(pₜ¹)−x(pₜ²))+0.5*(x(pₜ³)−x(pₜ⁴)),

hₜ=0.5*(y(pₜ²)−y(pₜ⁴))+0.5*(y(pₜ³)−y(pₜ¹)).

The following estimates are defined by ƒ_{w}, ƒₕ, ƒₓ, ƒ_{y}:

Δwₜ₊₁=ƒ_{w}(Δwₜ,Δwₜ₋₁,Δwₜ₋₂, . . . ),

Δhₜ₊₁=ƒₕ(Δhₜ,Δhₜ₋₁,Δhₜ₋₂, . . . ),

Δxₜ₊₁=ƒₓ(Δxₜ,Δxₜ₋₁,Δxₜ₋₂, . . . ),

Δyₜ₊₁=ƒ_{y}(Δyₜ,Δyₜ₋₁,Δyₜ₋₂, . . . ),

The TTC can be determined using the above variables Δwₜ₊₁, Δhₜ₊₁, Δxₜ₊₁ and, Δyₜ₊₄ with a function ƒ_{TCC} which is represented by the following formula:

TTCₜ₊₁=ƒ_{TCC}(Δwₜ₊₁,Δhₜ₊₁,Δxₜ₊₁,Δyₜ₊₁ . . . )

FIG. 26 illustrates a flowchart of a fourth embodiment for identifying objects on the rearview mirror display device. Similar reference numbers will be utilized throughout for already introduced devices and systems. Blocks 110-116 represent various sensing devices such as SBZA, PA, RTCA, and a rearview camera.

In block 164, a sensor fusion technique is applied to the results of each of the sensors fusing the objects of images detected by the image capture device with the objects detected in other sensing systems. Sensor fusion allows the outputs from at least two obstacle sensing devices to be performed at a sensor level. This provides richer content of information. Both detection and tracking of identified obstacles from both sensing devices is combined. The accuracy in identifying an obstacle at a respective location by fusing the information at the sensor level is increased in contrast to performing detection and tracking on data from each respective device first and then fusing the detection and tracking data thereafter. It should be understood that this technique is only one of many sensor fusion techniques that can be used and that other sensor fusion techniques can be applied without deviating from the scope of the invention.

In block 166, the object detection results from the sensor fusion technique are identified in the image and highlighted with an object image overlay (e.g., Kalaman filtering, Condensation filtering).

In block 120, the highlighted object image overlay are displayed on the dynamic rearview mirror display device.

While certain embodiments of the present invention have been described in detail, those familiar with the art to which this invention relates will recognize various alternative designs and embodiments for practicing the invention as defined by the following claims.

What is claimed is:

1. A method of displaying a captured image on a display device of a driven vehicle comprising the steps of:
capturing a scene exterior of the driven vehicle by an at least one vision-based imaging device mounted on the driven vehicle;
sensing objects in a vicinity of the driven vehicle;
generating an image of the captured scene by a processor, the image being dynamically expanded to include sensed objects in the image;
highlighting sensed objects in the dynamically expanded image, the highlighted objects identifying objects proximate to the driven vehicle that are potential collisions to the driven vehicle; and
displaying the dynamically expanded image with highlighted objects in the display device.

2. The method of claim 1 further comprising the step of:
generating an interior component image overlay, the interior component image overlay including a replication of interior components of the driven vehicle as would be seen by a driver viewing a reflection through a rearview mirror;
displaying the interior component image overlay on the display device.

3. The method of claim 1 wherein highlighting detected objects in the dynamically expanded image includes overlaying an alert symbol on the object in the dynamically expanded image, the alert symbol identifying the object having a potential to collide with the driven vehicle.

4. The method of claim 1 wherein highlighting sensed objects in the dynamically expanded image includes overlaying an object overlay on the object for identifying captured vehicles proximate to the driven vehicle, the object overlay identifying an awareness condition of a vehicle relative to the driven vehicle.

5. The method of claim 4 wherein the object overlay identifying an awareness condition includes generating an object overlay boundary around the vehicle that represents a size of the vehicle in the dynamically expanded image.

6. The method of claim 5 wherein highlighting detected objects in the dynamically expanded image further includes overlaying an alert symbol on the vehicle having a potential to collide with the driven vehicle, the alert symbol providing a redundant warning to the driver.

7. The method of claim 6 further comprising the steps of:
determining a time-to-collision warning relating the highlighted object; and
displaying the time-to-collision warning on the display device.

8. The method of claim 7 wherein determining the time-to-collision further comprises the steps of:
detecting an object at a first instance of time and at a second instance of time;
determining a size of the object at the first instance of time and the second instance of time;
determining a change in the distance from the driven vehicle to the object as a function of the determined size of the object at the first and second instances of time;
determining a velocity of the object as a function of the change in the distance over time; and
calculating the time-to-collision as a function of an estimated distance between object and the driven vehicle and a determined velocity of the object.

9. The method of claim 8 wherein determining the size of the object further comprises the step of defining the object size as an object detection window, wherein the object detection window at time t is represented by the following formula:
winₜ^{det}:(uWₜ,vHₜ,vBₜ):
where uWₜ is the detected window width; vHₜ is the detected window height; and, vBₜ is the detected window bottom.

10. The method of claim 9 wherein an observed object size and distance of an object to a driven vehicle is represented by the following formula:
xₜ=(wₜ^{o},hₜ^{o},dₜ^{o})
where wₜ^{o} is an observed object width, hₜ^{o} is an observed object height, and dₜ^{o} is an observed object distance at time t.

11. The method of claim 10 wherein the observed object size and distance based on a camera calibration is determined utilizing an in-vehicle window size and location and is represented by the following equation:
$${win}_{t}^{det} \text{:} ( {uW}_{t} , {vW}_{t} , {vB}_{t} ) {\to }^{CamCalib} {X}_{t} \text{:} ( {w}_{t}^{o} , {h}_{t}^{o} , {d}_{t}^{o} ) .$$

12. The method of claim 11 further comprising the step of estimating output parameters of the object as a function of the observed object size and distance parameters and is represented by the following formula:
def:Yₜ=(wₜ^{e},hₜ^{e},dₜ^{e},vₜ)
where wₜ^{e} is an estimated object size of the object at time t, hₜ^{e} is an estimated distance of the object at time t, dₜ^{e} is an estimated distance of the object at time t, and vₜ is a relative speed of the object at time t.

13. The method of claim 12 wherein the estimated object size of the object at time t is determined by the following formula:
$$estimated object size \text{:} {w}_{t}^{e} = \frac{{\sum }_{i = 0}^{n} {w}_{t - i}^{o}}{n + 1} , {h}_{t}^{e} = \frac{{\sum }_{i = 0}^{n} {h}_{t - i}^{o}}{n + 1} .$$

14. The method of claim 13 wherein the estimated object distance of the object at time t is determined by the following formula:
estimated object distance: dₜ^{e}=dₜ^{o}.

15. The method of claim 14 wherein the estimated object speed relative to the vehicle is represented by the following formula:
$$estimated object relative speed \text{:} {v}_{t} = \frac{Δ d}{Δ t} = ( {d}_{t}^{e} - {d}_{t - 1}^{e} ) / Δ t .$$

16. The method of claim 15 wherein the time-to-collision of the object is represented by the following formula:
TTC:TTCₜ=dₜ^{e}/vₜ.

17. The method of claim 6 wherein determining the time-to-collision further comprises the following steps:
detecting an object at a first instance of time and at a second instance of time;
determining a size of the object at the first instance of time and at the second instance of time;
determining a change in the object size between the first and second instances of time;
determining an occupancy of the object in the captured images at the first and the second instances of time; and
calculating the time-to-collision as a function of the determined change in size of the object between the captured image and the occupancy of the object at the first and second instances of time.

18. The method of claim 17 wherein determining the change in the object size comprises the following steps:
identifying the object overlay boundary that includes identifying a height boundary, a width boundary, and corner points of the object overlay boundary; and
determining a change in height, width, and corner points of the object overlay boundary.

19. The method of claim 19 wherein determining the change in height, width, and corner points of the object overlay boundary is represented by the following equations:
Δwₜ=wₜ−wₜ₋₁,
Δhₜ=hwₜ−hₜ₋₁,
Δx(pₜⁱ)=x(pₜⁱ)−x(pₜ₋₁ⁱ),Δy(pₜⁱ)−y(pₜⁱ)−y(pₜ₋₁ⁱ)
where
wₜ=0.5*(x(pₜ¹)−x(pₜ²))+0.5*(x(pₜ³)−x(pₜ⁴)),
hₜ=0.5*(y(pₜ²)−y(pₜ⁴))+0.5*(y(pₜ³)−y(pₜ¹)),
and where wₜ is the object width at time t, hₜ is the object height at time t, and pₜⁱ is the corner points, i=1, 2, 3, or 4, at time t.

20. The method of claim 19 further comprising the steps of estimating changes to the object size and location at a next instance of time, wherein the changes to the object size and location at the next instance of time is represented by the following formula:
Δwₜ₊₁=ƒ_{w}(Δwₜ,Δwₜ₋₁,Δwₜ₋₂, . . . ),
Δhₜ₊₁=ƒₕ(Δhₜ,Δhₜ₋₁,Δhₜ₋₂, . . . ),
Δxₜ₊₁=ƒₓ(Δxₜ,Δxₜ₋₁,Δxₜ₋₂, . . . ),
Δyₜ₊₁=ƒₓ(Δyₜ,Δyₜ₋₁,Δyₜ₋₂, . . . )

21. The method of claim 20 wherein determining the time-to-collision is determined by the following formula:
TTCₜ₊₁=ƒ_{TCC}(Δwₜ₊₁,Δhₜ₊₁,Δxₜ₊₁,Δyₜ₊₁ . . . )

22. The method of claim 1 further comprising the steps of:
detecting objects using at least one additional sensing device; and
applying sensor fusion of the objects sensed by the additional sensing device and the at least one vision-based imaging device mounted on the driven vehicle for cooperatively identifying objects for highlighting.

23. The method of claim 1 wherein objects are sensed by the at least one vision-based imaging device.

24. The method of claim 23 wherein objects are sensed by a vehicle-based sensing system.

25. The method of claim 24 wherein a plurality of vehicle based sensing systems are cooperatively used to identify objects exterior of the vehicle, wherein the sensed objects are highlighted in the displayed image, wherein highlighting the sensed objects includes generating a warning symbol overlay on the object in the display device.

26. The method of claim 24 wherein a plurality of vehicle based sensing systems are cooperatively used to identify objects exterior of the vehicle, wherein the sensed objects are highlighted in the displayed image, wherein highlighting the sensed objects includes generating a boundary overlay on the objects in the display device.

27. The method of claim 24 wherein a plurality of vehicle based sensing systems are cooperatively used to identify objects exterior of the vehicle, wherein the sensed objects are highlighted in the displayed image, wherein highlighting the sensed objects includes generating a warning symbol and a boundary overlay on the objects in the display device.

28. The method of claim 1 wherein the dynamically expanded image is displayed on a rearview mirror display device.
